(19) United States
(12) Patent Application Publication
(10) Pub. No.: US 2016/0052326 A1
(43) Pub. Date: Feb. 25, 2016

(54) Lens-Foil Based Security Device

(71) Applicant: INNOVIA SECURITY PTY LTD, Craigieburn, Victoria (AU)

(72) Inventors: Karlo Ivan Jolic, Craigieburn, VIC (AU); Odi Batistatos, Craigieburn, VIC (AU); Gary Fairless Power, Craigieburn, VIC (AU); Ben Paul Stevens, Craigieburn, VIC (AU)

(73) Assignee: Innovia Security Pty Ltd, Craigieburn, VIC (AU)

(21) Appl. No.: 14/779,724

(22) PCT Filed: Mar. 24, 2014
(86) PCT No.: PCT/AU2014/000304

§ 371 Date: Sep. 24, 2015

(30) Foreign Application Priority Data
Mar. 27, 2013 (AU) 2013100374
Mar. 27, 2013 (AU) 2013901056

(51) Int. Cl. B42D 25/36

(52) U.S. Cl. CPC B42D 25/36

(57) ABSTRACT

A security document includes a substrate including a first surface and a second surface; a foil located in a region of the substrate on the first surface and including a first security element: and a second security element located in a different region of the substrate. The first and second security elements are configured to provide a visual effect when overlapping. The second security element is formed from an embossable material applied directly to the surface of the substrate. A method is for the production thereof.

### FIELD OF THE INVENTION

The invention generally relates to security effects for security documents, in particular security documents incorporating foils and microlenses.

### BACKGROUND TO THE INVENTION

Foils for banknotes have been available for many decades. They have the ability to provide security with highly reflective designs. The foils are thin (a few microns) and when applied (via hot stamping) to a banknote, the foils can be housed in reserved areas on the banknotes relatively easily.

However, prior art attempts to incorporate microlenses with a foil (in varying configurations), results in increased thickness of the foil, which is undesirable when the foil is applied to a banknote. A typical commercially available foil (including lenses on one side and imagery on the opposite side) is approximately 40 microns thick. When such a foil is attached to a typical paper banknote substrate, the total thickness in the area of the foil is significantly greater than the other areas of the banknote. When many sheets containing such foils with microlenses are stacked together, they develop a non-uniform height profile, which can cause problems in feeding of the sheets in the subsequent banknote printing processes such as intaglio. Also, because the foil is much thicker than the rest of the banknote, a counterfeiter may attempt to simulate the foil, by attaching something to the substrate. This problem is due to prior art methods of arranging diffractive and/or non-diffractive elements for imaging by the microlens array on the opposite side of the foil to the microlenses. In order to provide satisfactory focus of the microlenses onto the diffractive and/or non-diffractive elements, a suitably thick foil must be provided.

Due to the limitations on the thickness of foils applied to banknotes, any lenticular image (consisting of an array of microlenses and corresponding imagery components configured for viewing through the lenses) deployed in a foil are limited to a small range of potential visual effects. The thickness limitation of the foil results in a limit on the width of each microlens. The limited microlens width constrains the amount of imagery information that can be placed underneath each microlens on the lens reverse side. In turn this limits the range of visual effects that can be achieved. For example, the achievable visual effects are typically limited to magnifying Moiré effects, simple 2-flip imagery, and contrast-switch imagery.

### SUMMARY OF THE INVENTION

According to a first aspect of the present invention, there is provided a security document including: a substrate including a first surface and a second surface; a foil located in a region of the substrate on the first surface and including a first security element; and a second security element located in a different region of the substrate, wherein the first and second security elements are configured to provide a visual effect when overlapping, and wherein the second security element is formed from an embossable material applied directly to the surface of the substrate.

According to another aspect of the present invention, there is provided a method for production of a security document, including the steps of: providing a substrate including a region of radiation curable ink; providing a foil configured for hot stamping onto the substrate, the foil including a first security element; embossing a second security element in the region of radiation curable ink; and applying the foil onto a surface of the substrate in a region different to the second security element, wherein the first and second security elements are configured to provide a visual effect when overlapping.

Preferably, one of the first and second security elements includes imagery elements and the other of the first and second security elements includes an array of microlenses.

The second security element may be located on the second surface of the security document. In this case, the second security element may be located fixedly opposite and overlapping the first security element, such that the imagery components are viewable through the microlenses of the microlens array. Alternatively, the second security element may be located non-opposite the first security element, and the visual effect may be observable when the first security element is positioned overlapping the second security element.

Alternatively, optionally the second security element is located on the first surface in a different region to the first security element, and the visual effect is observable when the first security element is positioned overlapping the second security element, such that the imagery elements are viewed through at least two layers of the substrate.

The imagery elements may correspond to diffractive elements.

Preferably, the microlenses are formed from an embossed radiation curable ink. The radiation curable ink may be a UV curable ink. Each microlens may have a sag within the range 5 to 35 microns, preferably 10 microns. Each microlens may have a pitch within the range 25 to 160 microns, preferably 63.5 microns. Each microlens may have a refraction index within the range 1.3 to 2.2, preferably 1.5. The total thickness of the microlenses may be within the range 10 to 20 microns.

Preferably, the visual effect is due to the microlenses being (or being operated as) one or both (preferably one) of concave and convex lenses. Advantageously, the visual effect includes one or more of: animation; morphing; zoom; and full 3-D.

Preferably, the foil is applied to the substrate using a hot stamping process. The total thickness of the foil may be within the range 10 to 20 microns. The foil may include a secondary visual effect, the secondary visual effect is configured for viewing without the use of a microlens array. The secondary visual effect may be a diffractive, for example holographic, visual effect.

The, or each, array of microlenses may include one of more of the following: spherical lenses, part-spherical lenses, aspherical lenses, cylindrical lenses, part-cylindrical lenses, Fresnel lenses, diffractive lenses, and zone plates.

Optionally, the first security element includes a first array of microlenses and the second security element includes a second array of microlenses.

The security document may be a banknote.

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. Diffraction gratings and optically variable devices, when described herein, may also have application in other products, such as packaging.

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Refractive Index n

The refractive index of a medium n is the ratio of the speed of light in vacuum to the speed of light in the medium. The refractive index n of a lens determines the amount by which light rays reaching the lens surface will be refracted, according to Snell's law:

n₁*Sin(α)=n*Sin(θ),

where α is the angle between an incident ray and the normal at the point of incidence at the lens surface, θ is the angle between the refracted ray and the normal at the point of incidence, and n₁ is the refractive index of air (as an approximation n₁ may be taken to be 1).

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

### Region

A region, as used herein, corresponds to an area of a surface of a security document or a substrate. For example, a first region located on a first side of a substrate is a different region to a second region located on a second side of the same substrate, even when the two regions are opposite one another. Two regions can be: opposite, wherein each region is located in the same area of the security document or substrate but on opposite surfaces; partially opposite, wherein one region includes a portion opposite all or a portion of the other region; and non-opposite, wherein the regions are entirely not opposite each other.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 shows a security device including a foil and a selection device;

FIG. 2a shows a security document including a first region including a radiation curable ink (RCI);

FIG. 2b shows a security document including an embossed microlens array;

FIG. 3 shows a foil including a diffraction pattern;

FIG. 4 shows an arrangement of a microlens array and a foil located opposite one another on different surfaces of a security document;

FIG. 5 shows an arrangement of a microlens array and a foil located non-opposite one another on different surfaces of a security document;

FIG. 6 shows a security document in a folded configuration such that the microlenses act as convex lenses;

FIG. 7 shows a security document in a folded configuration such that the microlenses act as concave lenses;

FIG. 8 shows an arrangement of a microlens array and a foil located in different regions on the same surface of a security document;

FIG. 9 shows an arrangement of line elements of a line screen and a foil;

FIG. 10 shows a security document including a foil and a line screen;

FIG. 11 shows a foil including a microlens array;

FIG. 12 shows a foil including a microlens array opposite a security element including imagery components; and

FIG. 13 shows a foil including a microlens array opposite a security element including another microlens array.

### DESCRIPTION OF PREFERRED EMBODIMENTS

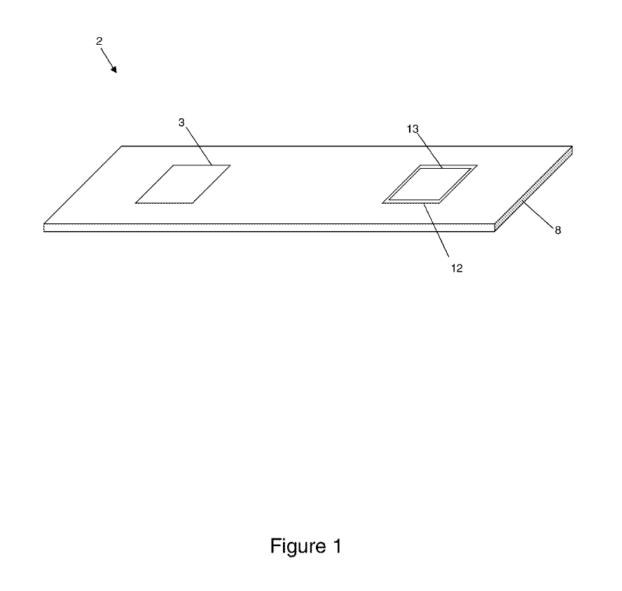

Referring to FIG. 1, there is provided a security document 2 including a substrate 8, a foil 12 including a first security element 13, and a second security element 3 formed on a surface of the substrate. In the figure, the second security element 3 and the foil 12 are shown located in different regions on the same side of the substrate 8, however as discussed below other configurations are possible.

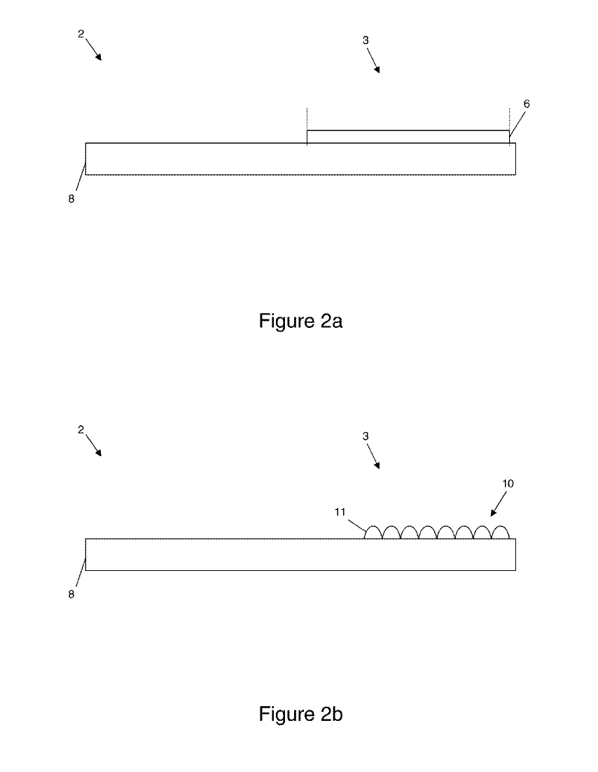

According to an embodiment, with reference to FIG. 2a, a radiation curable ink (RCI) 6 is printed onto the substrate 8 and embossed and cured, thereby forming the second security element 3. Alternatively, any suitable embossable material can be used in place of radiation curable ink. The RCI 6 or other material can be applied to the substrate 8 using known printing techniques, for example intaglio printing, gravure printing, ink-jet printing, etc. Alternatively, the second security element 3 can be formed using other known techniques.

According to an embodiment, the RCI 6 is embossed with a lens structure forming a microlens array 10 including a plurality of microlenses. The microlens array 10 (including a plurality of microlenses 11), as shown in FIG. 2b, can correspond to a 2D array of spherical lenses, a 1D array of cylindrical lenses, or any other suitable lens array. In a particular embodiment, the microlens array 10 corresponds to an array of one of spherical lenses or cylindrical lenses, and each microlens 11 of the microlens array 10 can have a sag of 5-35 microns, preferably 10 microns, and a pitch of 25-160 microns, preferably 63.5 microns. Furthermore, the microlenses 11 can have a refractive index between 1.3 and 2.2, preferably between 1.4 and 1.6, and more preferably close to, or equal to, 1.5. At the same time as embossing the RCI 6, or shortly afterwards, the RCI 6 is irradiated with suitable radiation in order to cure the RCI 6. Suitable radiation can be UV radiation. The microlenses 11 can be configured for focussing through the thickness of the substrate 8 (which may be approximately 75 microns). Alternatively, the microlenses 11 can be configured for focussing through two layers of substrate 8 (i.e. due to the substrate 8 being folded), for example through approximately 150 microns corresponding to twice the thickness of the substrate 8. The microlenses 11 can instead be Fresnel lenses, which allows for reduced total thickness of the RCI 6.

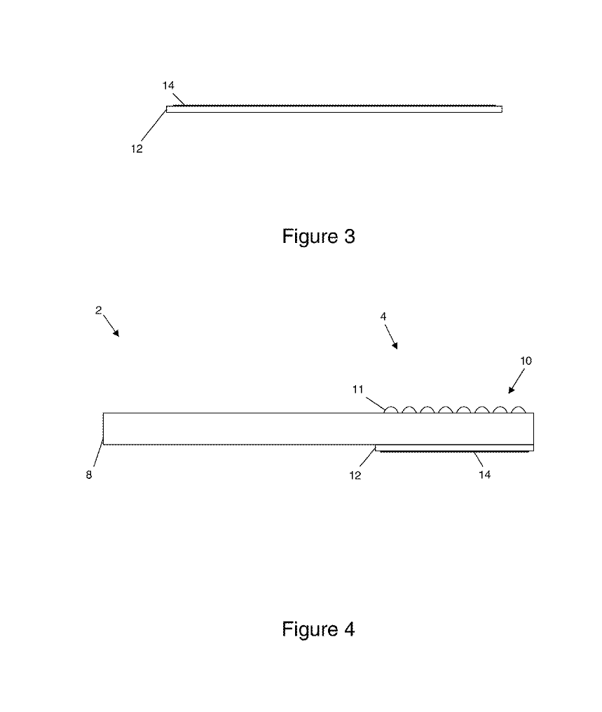

Referring to FIG. 3, the foil 12 is provided incorporating imagery components 14. The imagery components 14 can correspond to diffractive and/or non-diffractive elements, and are in general configured for providing a visual effect when viewed in conjunction with the second security element 3 (described in more detail below). In a particular embodiment, the imagery components 14 are arranged in a repeating pattern such that the components provide a visual effect when viewed in conjunction with the second security element 3, with the repeating pattern corresponding to the arrangement of lenses of the microlens array 10.

The foil 12 can be produced using known methods, and the imagery components 14 can be incorporated using known techniques. The foil 12 can be a vacuum metalised polymer. The foil 12 can have a thickness of approximately 9 microns. Each imagery component can correspond in surface area to an individual microlens 11. The foil 12 is hot stamped onto a region of the security document 2 using known hot stamping techniques. The foil 12 can be applied to the substrate 8 before, at the same time as, or after the second security element 3 is formed onto the substrate 8. The foil 12 including the imagery components 14 can be between 5 and 20 microns thick, preferably 9 microns.

Non-diffractive imagery components 14 include embossed recessed surface relief and/or embossed raised surface relief features. The surface relief features can be filled with ink (either between surface relief features or within surface relief features, as appropriate).

According to a first arrangement, as shown in FIG. 4, the microlens array 10 is located opposite the foil 12. The microlenses 11 are configured to view the imagery components 14 incorporated onto the foil 12, through the substrate 8.

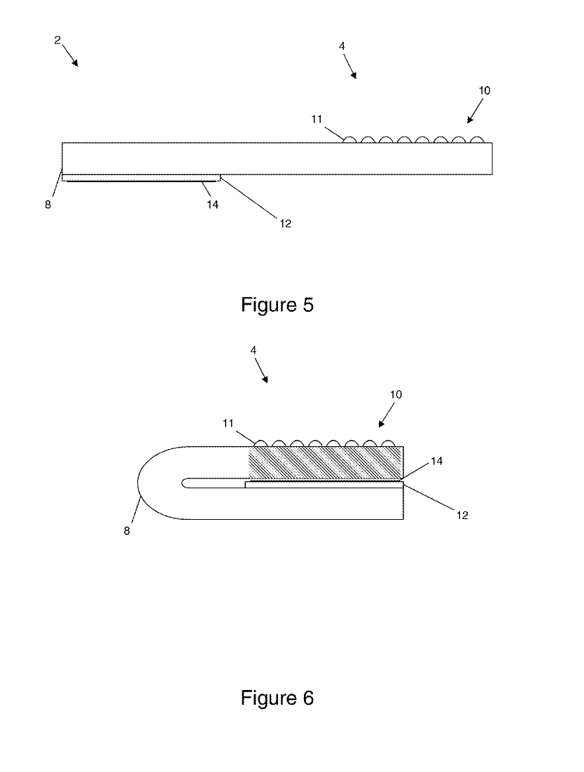

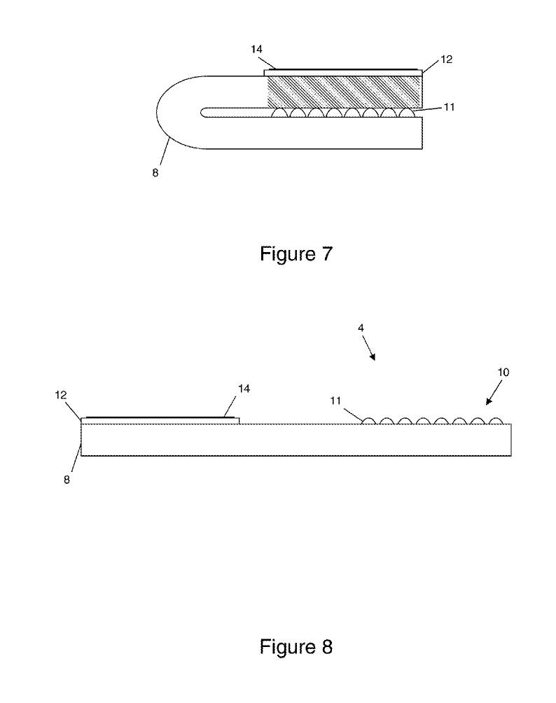

According to a second arrangement, as shown in FIG. 5, the microlens array 10 is located on the opposite surface of the substrate 8 to the foil 12; however the microlens array 10 is not located directly opposite the foil 12. Instead, the microlens array 10 is located in a region of the security document 2 that can be positioned over the foil 12 during use of the security document 2, for example by folding of the security document 2. FIG. 6 shows the security document 2 in such a folded configuration, such that the microlenses 11 operate as convex lenses and are configured to view the imagery components 14 of the foil through the substrate 8 (shown shaded in the figure). FIG. 7 shows the security document 2 in another folded configuration, such that the microlenses 11 operate as concave lenses and are configured to view the imagery components 14 of the foil through the substrate 8.

The foil 12 can be located in a window of the security document 2, in which case the microlens array 10 can be configured for viewing the imagery components 14 of the foil 12 in both a concave configuration (e.g. FIG. 7) and a convex configuration (e.g. FIG. 6). Alternatively, the foil 12 can be located in a half-window of the security document 2, in which case the microlens array 10 is configured for viewing imagery components 14 in one of the concave configuration (e.g. FIG. 7) or the convex configuration (e.g. FIG. 6).

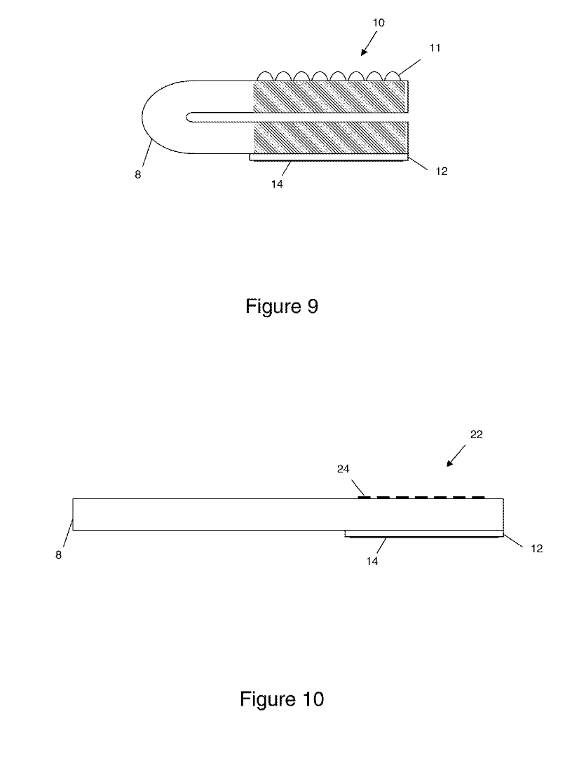

According to a third arrangement, as shown in FIG. 8, the microlens array 10 is located on the same surface of the substrate 8 as the foil 12, in two non-overlapping regions. As shown in FIG. 9, the substrate 8 can be folded such that the foil 12 is viewable through two parts of the substrate 8 (shown shaded in the figure). In this instance, the total distance between the microlens array 10 and the foil 12 when in contact is twice the substrate thickness, and the focal length of the microlenses 11 can be equal to twice the thickness of the substrate.

The microlenses 11 are configured with a focal length substantially the same as, or at least a relatively small deviation from, the thickness of the substrate 8 (or twice the thickness of the substrate 8 in the case of the third arrangement described above), such that the focal point of the microlenses 11 substantially corresponds with the position of the imagery elements 14. This provides the advantage of allowing for larger microlenses than would be possible if the first and second security elements 3, 13 were formed on opposite sides of the foil 12, as the substrate 8 is substantially thicker than the foil 12 and therefore more information can be associated with each microlens 11, allowing for more complicated visual effects, for example animation, morphing, zoom, full 3-D, and others. These visual effects are, for example, more complicated than other microlens based visual effects such as flipping image, contrast switch, and Moire effects.

It is noted that folded configurations in the figures are shown (for clarity) with a gap between adjacent surfaces. However, it can be usual preferable for the microlenses 11 to be configured for correct operation when adjacent surfaces are in direct contact.

In each arrangement, the imagery components 14, when viewed through the microlens array 10, are configured to display a visual effect corresponding to a security image, for example an optically variable image. Alternatively, or further, the microlens array 10 is configured to provide a security image when viewed through the diffractive pattern 14, in which case the foil 12 should be transparent or at least translucent.

The foil 12 can include a secondary image, different to the security image, which provides a further security effect. The secondary image is an image (which can be an optically variable image) which is viewable without the use of a microlens array 10. For example, considering the first arrangement, the secondary image can be associated with second side of the security document 2 opposite the side viewable through the microlens array 10. The secondary image can be, for example, a diffractive effect visible unaided, and therefore visible from the second side of the foil 12 without requiring the use of a microlens array 10. In order for this variation to be effective, it may be preferable to have an opaque metal layer of the foil, for example with an optical density of approximately 2. A foil 12 including imagery components 14 (for example, a diffractive pattern or a hologram) can have a total thickness less than 5 microns.

Microlenses 11 of the microlens array 10 can be configured for viewing the imagery components 14 of the foil 12 in focus or out of focus. The purpose of viewing the imagery components 14 out of focus is to allow for smooth transitions between adjacent imagery components 14.

It can be a requirement that the microlens array 10 and/or the foil 12 add minimal thickness to the security document 2. For example, the height above the substrate 8 of one or both of the microlens array 10 and the foil 12 can be limited to no more than 20 microns, preferably between 10 and 20 microns.

The foil 12 and the microlenses 11 can have a preferred relative orientation, such that when the foil 12 is hot stamped onto the substrate, the imagery components of the foil 12 are aligned in a particular relative alignment with respect to the microlenses 11. For example, when the microlenses 11 are cylindrical lenses, the longitudinal component can be arranged to run orthogonally to the imagery components 14. As the microlens array 10 and the foil 12 are fixedly located on the substrate 8, the relative alignments of the microlenses 11 and the diffraction pattern 14 can be fixed when the security document 2 is produced. When the arrangement is orthogonal, the visual effect when the imagery components 14 are viewed through the microlens array 10 will appear substantially black and white, whereas the diffraction pattern 14 when viewed without the use of the microlens array 10 (e.g. from the other side of the foil 12 to the microlens array 10, or when the microlens array 10 is not positioned over the foil 12) will appear coloured. This difference in appearance of the diffraction pattern 14 can give the appearance of more than one foil layer, particularly when incorporated into the first arrangement.

In an alternative embodiment, the microlenses are substituted for a line screen 22 as shown in FIG. 10. The line screen includes a plurality of line elements 24. The line screen 22 can be formed from an embossed RCI, or alternatively other marking techniques can be used, for example: laser marking; gravure printing; offset printing; flexographic printing; or intaglio printing. The line elements 24 of the line screen 22 operate to selective block areas of the foil 12 from view. Due to parallax effects, as the angle of view is changed different areas of the foil 12 are visible. This can provide a similar visual effect to that provided by microlenses, wherein the appearance of the foil 12 appears to change as the device is tilted.

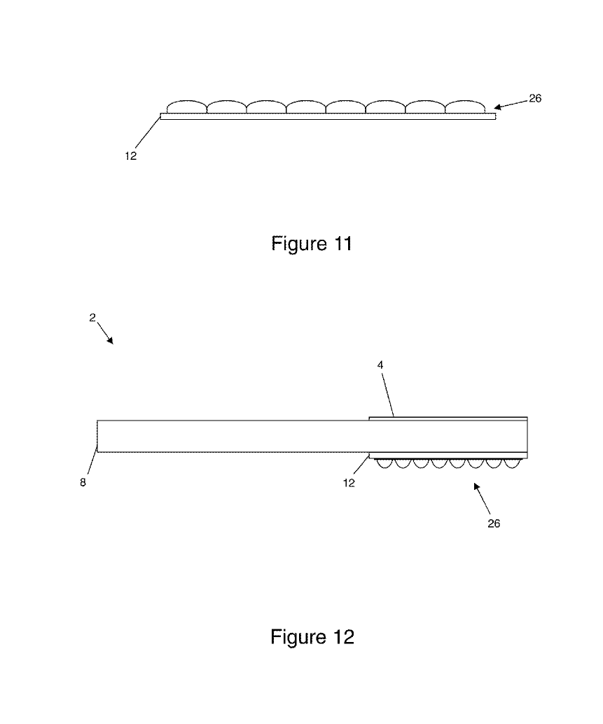

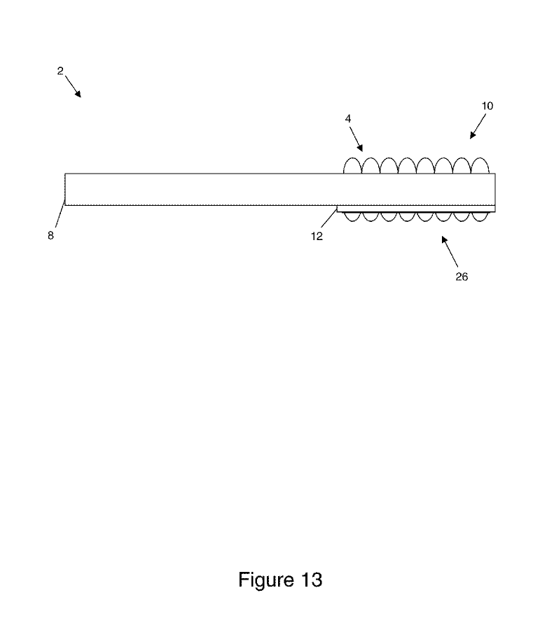

In another embodiment, with reference to FIG. 11, a foil microlens array 26 is formed on the foil 12. Referring to FIG. 12, the first region 4 of the substrate 8 can include imagery components (such as diffractive elements and/or non-diffractive elements as previously described) configured to provide a visual effect when viewed through the foil microlens array 26, analogously to previously described arrangements (in this case, analogous to the arrangement shown in FIG. 4). Such diffractive elements and/or non-diffractive elements can be formed by, for example, embossing and radiation curing of a radiation curable ink printed onto the first region 4. In a variation of this embodiment, the security document 2 includes both an embossed microlens array 10 and a foil microlens array 26, as shown in FIG. 13.

Further modifications and improvements may be made without departing from the scope of the present invention.

1-23. (canceled)

24. A security document comprising:
a) a substrate including a first surface and a second surface;
b) a foil located in a region of the substrate on the first surface and including a first security element; and
c) a second security element located in a different region of the substrate, wherein the first and second security elements are configured to provide a visual effect when overlapping, and wherein the second security element is formed from an embossable material applied directly to the surface of the substrate,
wherein the second security element is located on the second surface of the security document,
wherein the first security element includes imagery elements and the second security element includes an array of microlenses, and
wherein the second security element is located fixedly opposite and overlapping the first security element, such that the imagery components are viewable through the microlenses of the microlens array.

25. A method for production of a security document, the method comprising:
a) providing a substrate including a region of radiation curable ink;
b) providing a foil configured for hot stamping onto the substrate, the foil including a first security element;
c) embossing a second security element in the region of radiation curable ink; and
d) applying the foil onto a surface of the substrate in a region different to the second security element,
wherein the first and second security elements are configured to provide a visual effect when overlapping,
wherein the second security element is located on the second surface of the security document,
wherein the first security element includes imagery elements and the second security element includes an array of microlenses, and
wherein the second security element is located fixedly opposite and overlapping the first security element, such that the imagery components are viewable through the microlenses of the microlens array.

26. A security document as claimed in claim 24, wherein the imagery elements include diffractive elements.

27. A security document as claimed in claim 24, wherein each microlens has a sag falling substantially within the range from 5 μm to 35 μm.

28. A security document as claimed claim 24, wherein each microlens has a pitch falling substantially within the range from 25 μm to 160 μm.

29. A security document as claimed in claim 24, wherein each microlens has a refractive index falling substantially within the range from 1.3 to 2.2.

30. A security document as claimed in claim 24, wherein the total thickness of the microlenses falls substantially within the range from 10 μm to 20 μm.

31. A security document as claimed in claim 24, wherein the visual effect includes one or more of: animation; morphing; zoom; and full 3-D.

32. A security document as claimed in claim 24, wherein the, or each, array of microlenses includes one of more of the following: spherical lenses, part-spherical lenses, aspherical lenses, cylindrical lenses, part-cylindrical lenses, Fresnel lenses, diffractive lenses, and zone plates.

33. A security document as claimed in claim 24, wherein the total thickness of the foil is substantially within the range from 10 μm to 20 μm.

34. A security document as claimed in claim 24, wherein the foil includes a secondary visual effect, wherein the secondary visual effect is configured for viewing without the use of a microlens array.

35. A security document as claimed in claim 24, wherein the secondary visual effect is a diffractive, visual effect.

36. A security document as claimed in claim 34, the secondary visual effect is viewable from an opposite side of the foil to a side having the first security element.

37. A security document as claimed in claim 24, wherein the security document is a banknote.

38. A method according to claim 25, wherein the second security element is formed from an embossed radiation curable ink.

39. A method as claimed in claim 25, wherein the foil is applied to the substrate using a hot stamping process.

40. A method as claimed in claim 25, wherein the security document is a banknote.
